(19) United States
(12) Patent Application Publication
(10) Pub. No.: US 2016/0131090 A1
(43) Pub. Date: May 12, 2016

(54) VAPORIZED FUEL PROCESSING APPARATUS

(71) Applicant: AISAN KOGYO KABUSHIKI KAISHA, Obu-shi (JP)

(72) Inventor: Katsuhiko MAKINO, Aichi-ken (JP)

(73) Assignee: AISAN KOGYO KABUSHIKI KAISHA, Obu-shi (JP)

(21) Appl. No.: 14/922,412

(22) Filed: Oct. 26, 2015

(30) Foreign Application Priority Data
Nov. 7, 2014 (JP) 2014-226874

(51) Int. Cl. F02M 25/08; F02D 41/00; F02M 35/10

(52) U.S. Cl. CPC F02M 25/089; F02M 25/0836; F02M 25/0872; F02M 35/10222; F02D 41/004

(57) ABSTRACT

A vaporized fuel processing apparatus for an engine, which includes an air supply passage equipped with a throttle valve, has an adsorbent canister and a purge passage communicating the adsorbent canister with the air supply passage of the engine. The adsorbent canister is adapted to communicate with a fuel tank. The purge passage includes a first purge passage and a second purge passage such that the first purge passage is formed in parallel with the second purge passage. The first purge passage has a first purge valve. The second purge passage has in series a second purge valve and a purge pump. The first purge passage and the second purge passage are configured such that pressure loss in the second purge passage is less than pressure loss in the first purge passage.

### CROSS-REFERENCE TO RELATED APPLICATIONS

This application claims priority to Japanese patent application serial number 2014-226874, filed Nov. 7, 2014, the contents of which are incorporated herein by reference in their entirety for all purposes.

### STATEMENT REGARDING FEDERALLY SPONSORED RESEARCH OR DEVELOPMENT

Not applicable.

### BACKGROUND

This disclosure relates to a vaporized fuel processing apparatus having a purge pump for purging fuel vapor adsorbed in an adsorbent canister.

Japanese Laid-Open Patent Publication No. 2008-240641 discloses a vaporized fuel processing apparatus having a purge pump on a purge passage for forcibly purging fuel vapor from an adsorbent canister.

In the vaporized fuel processing apparatus of Japanese Laid-Open Patent Publication No. 2008-240641, when pressure loss by a purge valve provided in the purge passage is large, the purge pump cannot sufficiently increase purge flow rate. Therefore, there has been a need for an improved vaporized fuel processing apparatus.

### BRIEF SUMMARY

In one aspect of this disclosure, a vaporized fuel processing apparatus for an engine, which includes an air supply passage equipped with a throttle valve, has an adsorbent canister and a purge passage communicating the adsorbent canister with the air supply passage of the engine. The adsorbent canister is adapted to communicate with a fuel tank. The purge passage includes a first purge passage and a second purge passage such that the first purge passage is formed in parallel with the second purge passage. The first purge passage has a first purge valve. The second purge passage has in series a second purge valve and a purge pump. The first purge passage and the second purge passage are configured such that pressure loss in the second purge passage is less than pressure loss in the first purge passage.

According to this aspect of this disclosure, because the pressure loss in the second purge passage is less than the pressure loss in the first purge passage, a purge flow rate can be sufficiently increased by working the purge pump.

### BRIEF DESCRIPTION OF THE DRAWINGS

FIG. 1 is a schematic diagram of a vaporized fuel processing apparatus in a first example.

FIG. 2 is a flowchart showing a process for controlling a purge operation.

FIG. 3 is a graph showing a relationship between a desired purge flow rate and a pressure in an air supply pipe during the controlled purge operation.

FIG. 4 is a flowchart showing the process for controlling the purge operation in a second example.

FIG. 5 is a graph showing a relationship between an estimated purge flow rate and the pressure in the air supply pipe during the controlled purge operation in the second example.

FIG. 6 is a flowchart showing the process for controlling the purge operation in a third example.

FIG. 7 is a graph showing relationships between time and each of the purge flow rate and an air supply flow rate.

FIG. 8 is a schematic view of the vaporized fuel processing apparatus in a fourth example.

### DETAILED DESCRIPTION

Each of the additional features and teachings disclosed above and below may be utilized separately or in conjunction with other features and teachings to provide improved vaporized fuel processing apparatuses. Representative examples, which utilize many of these additional features and teachings both separately and in conjunction with one another, will now be described in detail with reference to the attached drawings. This detailed description is merely intended to teach a person of skilled in the art further details for practicing preferred aspects of the present teachings and is not intended to limit the scope of the invention. Only the claims define the scope of the claimed invention. Therefore, combinations of features and steps disclosed in the following detailed description may not be necessary in the broadest sense, and are instead taught merely to particularly describe representative examples. Moreover, various features of the representative examples and the dependent claims may be combined in ways that are not specifically enumerated in order to provide additional useful embodiments of the present teachings.

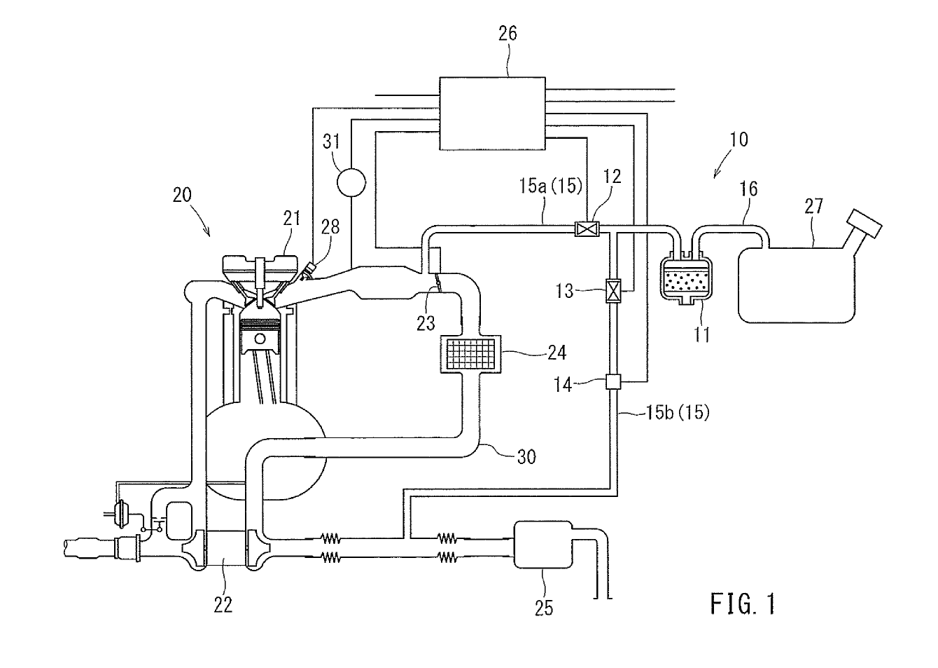

As shown in FIG. 1, a vaporized fuel processing apparatus 10 is combined with an internal combustion engine system 20 (referred to as “engine system”, hereinafter) having a turbocharger 22 as a supercharging device. The supercharging device such as supercharger, turbocharger or the like is a forced induction device for supplying compressed air to the engine system 20. Here, for convenience of explanation, upstream and downstream are defined based on gas flows of fuel vapor, air and the like through each component of both the engine system 20 and the vaporized fuel processing apparatus 10.

The engine system 20 has a known structure and is configured to supply mixed gas containing air and fuel to an engine body 21 (also, referred to as “engine”, hereinafter) through an air supply passage 30. The air supply passage 30 has an air cleaner 25, the turbocharger 22, an intercooler 24 and a throttle valve 23 in sequence from the upstream side toward the downstream side in an air flow direction. The throttle valve 23 regulates the flow rate of the air flowing through the air supply passage 30. The engine system 20 includes a fuel injection valve 28 for regulating the flow rate of the fuel into the engine 21. The throttle valve 23 and the fuel injection valve 28 are connected to a control unit 26. The throttle valve 23 outputs signals relating to a valve opening amount of the throttle valve 23 to the control unit 26. The control unit 26 controls a valve opening time of the fuel injection valve 28 based on the signals output from the throttle valve 23. The fuel injection valve 28 is supplied with liquid fuel from a fuel tank 27 via a fuel supply pipe (not shown). The air supply passage 30 is provided with a multifunctional sensor 31 downstream of the throttle valve 23. The multifunctional sensor 31 is configured to detect pressure and flow rate, etc. in the air supply passage 30 and to output signals to the control unit 26. Of course, the multifunctional sensor 31 can be replaced with a plurality of separate sensors for each detecting pressure, flow rate or the like.

In the vaporized fuel processing apparatus 10, the fuel vapor produced during refueling and/or vaporized in the fuel tank 27 is introduced into an adsorbent canister 11 via a vapor passage 16 and is captured in the adsorbent canister 11. Then, when the fuel vapor is purged from the adsorbent canister 11, the fuel vapor is introduced into the air supply passage 30 for the engine 21 via a purge passage 15. The purge passage 15 includes a first purge passage 15a and a second purge passage 15b. The first purge passage 15a has a first purge valve 12. The second purge passage 15b has a second purge valve 13 and a purge pump 14 in sequence from the upstream side toward the downstream side in a flow direction of the fuel vapor. The first purge passage 15a is connected to the air supply passage 30 (also, referred to as “air supply pipe”, hereinafter) downstream of the throttle valve 23. The second purge passage 15b is connected to the air supply passage 30 upstream of a compressor of the turbocharger 22. In a condition that the first purge valve 12 and the second purge valve 13 are full open, the second purge valve 13 has an opening area larger than that of the first purge valve 12. For example, the opening area of the full open second purge valve 13 is larger than two times of the opening area of the first purge valve 12. The second purge valve 13 comprises an on-off valve having a large diameter, which may not attach importance to a flow rate controllability and a responsiveness, such as a shut off valve. Thus, pressure loss in the second purge passage 15b is smaller than pressure loss in the first passage 15a.

The first purge valve 12, the second purge valve 13 and the purge pump 14 are connected to the control unit 26. When the control unit 26 determines that the vaporized fuel processing apparatus 10 is in a condition capable of purging based on an operation state of the engine 21 and the like, the first purge valve 12 is opened for allowing fluid communication through the first purge passage 15a, and the second purge valve 13 and the purge pump 14 are controlled as described below, thereby flowing the mixed gas containing the fuel vapor and the air through at least one of the first purge passage 15a and the second purge passage 15b.

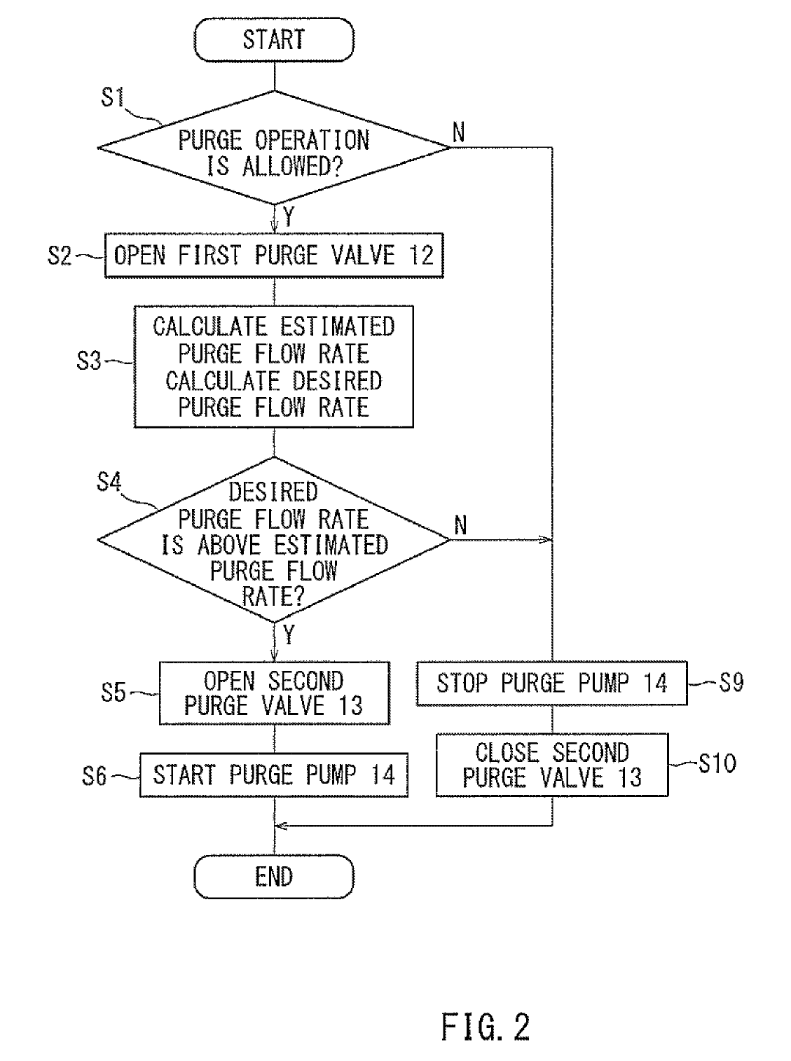

The control unit 26 repeatedly carries out a purge control process shown in FIG. 2. After starting this process, the control unit 26 determines whether the purge operation is allowed at Step S1. When a feedback control of an air-fuel ratio is performed in a process for controlling the air-fuel ratio for the engine 21 (not shown), the purge operation is allowed such that Step S1 is determined as Yes. Then, the first purge valve 12 is opened at Step S2. When the first purge valve 12 is opened, the adsorbent canister 11 is purged via the first purge passage 15a.

At Step S3, the control unit 26 calculates an estimated purge flow rate, which is an estimate value of the purge flow rate through the first purge passage 15a, and a desired purge flow rate at the time. The estimated purge flow rate is calculated, for example, according to one of following methods: (A) calculating the estimated purge flow rate based on the pressure in the air supply passage 30 and the valve opening amount of the first purge valve 12, (B) calculating the estimated purge flow rate based on a pressure in a gaseous area in the fuel tank 27, a tank port of the adsorbent canister 11, or a purge port of the adsorbent canister 11, and (C) calculating the estimated purge flow rate based on a flow rate through an atmospheric port of the adsorbent canister 11. On the other hand, the control unit 26 estimates an amount of the fuel vapor captured in the adsorbent canister 11 based on the operation state of the engine 21, the ambient temperature or the like in the past, and then calculates the desired purge flow rate based on the estimated amount of the fuel vapor. At Step S4, the desired purge flow rate and the estimated purge flow rate, which have been calculated at Step S3, are compared with each other. When the desired purge flow rate is equal to or higher than the estimated purge flow rate, Step S4 is determined as Yes. Then, the second purge valve 13 is opened at Step S5, and the purge pump 14 is started at Step S6. When the second purge valve 13 is opened and the purge pump 14 is operated, the adsorbent canister 11 is purged via the second purge passage 15b.

When Step S1 is determined as No in a condition that the purge operation is not allowed, the first purge valve 12 is not opened such that the purge operation for the adsorbent canister 11 is not performed. Further, after Step S1 is determined as Yes, when the desired purge flow rate is less than the estimated purge flow rate, Step S4 is determined as No. Then, the purge pump 14 is stopped at Step S9, and the second purge valve 13 is closed at Step 10 such that the purge operation via the first purge passage 15a is carried out and such that the purge operation via the second purge passage 15b is blocked.

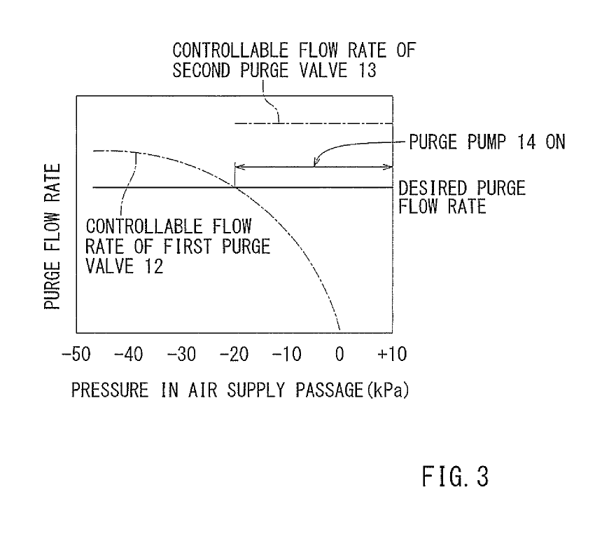

FIG. 3 shows relationships between the pressure in the air supply passage 30 and both a controllable flow rate of the first purge valve 12 and a controllable flow rate of the second purge valve 13. Here, the controllable flow rate is a maximum flow rate of the mixed gas flowing through the full open first purge valve 12 or the full open second purge valve 13 in each condition. In particular, because the purge operation via the first purge passage 15a having the first purge valve 12 depends on negative pressure in the air supply passage 30 downstream of the throttle valve 23, the controllable flow rate of the first purge valve 12 decreases based on increase in the pressure in the air supply passage 30 as viewed in FIG. 3. By contrast, because the purge operation via the second purge passage 15b having the second purge valve 13 depends on the purge pump 14, the controllable flow rate of the second purge valve 13 is constant while the purge pump 14 keeps a discharge flow rate constant. When the desired purge flow rate is less than the controllable flow rate of the first purge valve 12, the vaporized fuel processing apparatus 10 can be controlled such that the desired purge flow amount is accomplished by the purge operation via the first purge passage 15a having the first purge valve 12 without working the purge pump 14. In this condition, the purge flow rate is regulated by controlling the valve opening amount of the first purge valve 12. The control of the valve opening amount of the first purge valve 12 is carried out by, for example, pulse-width modulation of a duty cycle. On the other hand, when the desired purge flow rate is higher than the controllable flow rate of the first purge valve 12, the desired purge flow rate cannot be accomplished by the purge operation via the first purge passage 15a, so that the second purge valve 13 is opened and the purge pump 14 is operated. In this condition, the purge flow rate is regulated by controlling the discharge flow rate from the purge pump 14. Because the opening area of the second purge valve 13 in the full open condition is larger than that of the first purge valve 12, the pressure loss at the second purge valve 13 in the second purge passage 15b is less than the pressure loss at the first purge valve 12 in the first purge passage 15a. Thus, the controllable flow rate of the second purge valve 13 is sufficiently higher than that of the first purge valve 12. In addition, the desired purge flow rate is lower than the controllable flow rate of the second purge valve 13. Accordingly, the desired purge flow rate can be accomplished by the purge operation via the second purge passage 15b. Here, the purge flow rate through the second purge passage 15b is regulated by controlling the discharge flow rate from the purge pump 14, so that a control accuracy, a responsiveness and the like are low in comparison with a case that the purge flow rate through the first purge passage 15a is regulated by controlling the valve opening amount of the first purge valve 12. However, because the flow rate of the air supplied to the engine 21 is large in the condition that the purge operation via the second purge passage 15b is performed, the low control accuracy of the purge flow rate and the low responsiveness do not have a large influence on variation in the air-fuel ratio in the engine 21.

According to the first example, because the pressure loss at the second purge valve 13 disposed in the second purge passage 15b having the purge pump 14 is small, the purge flow rate via the second purge passage 15b is high while the purge pump 14 is running In addition, in a condition that a required purge flow rate is accomplished by the purge operation via only the first purge passage 15a, the purge pump 14 is not operated, so that energy consumption for running the purge pump 14 can be decreased, thereby preventing deterioration of fuel economy of the engine 21. Further, because the second purge passage 15b is connected to the air supply passage 30 upstream of the compressor of the turbocharger 22, supercharging by the turbocharger 22 does not cause back pressure of the purge pump 14 to become high. Thus, a load on the purge pump 14 can be reduced, thereby preventing the deterioration of fuel economy of the engine 21.

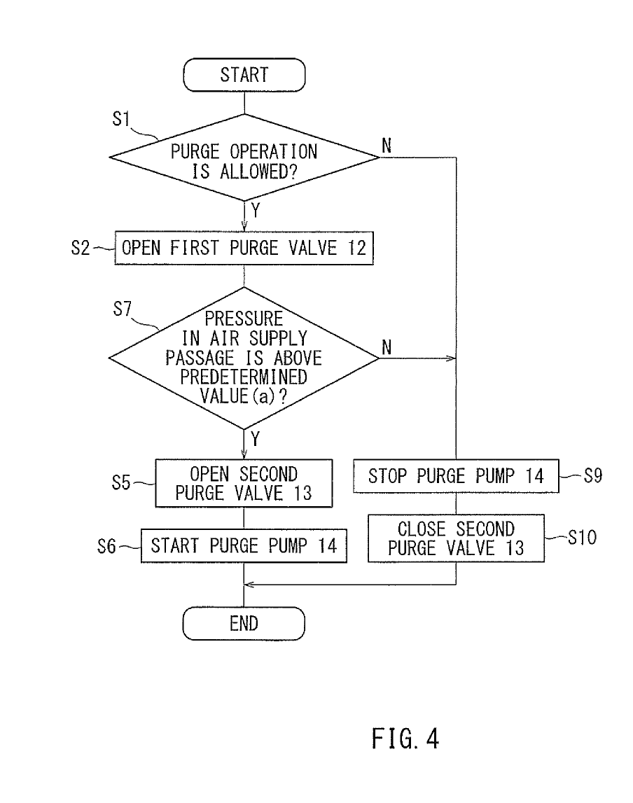

In a second example, the control unit 26 repeatedly performs a process for controlling the vaporized fuel processing apparatus 10 shown in FIG. 4. The second example generally corresponds to the first example, so that only the differences between the second example and the first example will be described, and the other same or shared configurations will not be described again.

In the second example, after the purge operation is allowed at Step S1 and the first purge valve 12 is opened at Step S2, the control unit 26 determines whether the pressure in the air supply passage 30 downstream of the throttle valve 23 is equal to or higher than a predetermined value (a) at Step S7. When the pressure in the air supply passage 30 is equal to or higher than the predetermined value (a), Step S7 is determined as Yes. Then, the second purge valve 13 is opened at Step S5, and the purge pump 14 is started at Step S6.

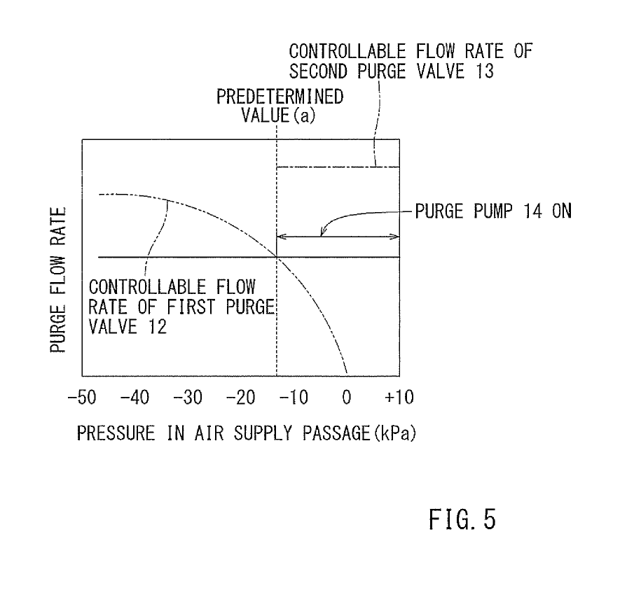

FIG. 5 shows relationships between the pressure in the air supply passage 30 and the controllable flow rates of both the first purge valve 12 and the second purge valve 13 in the second example. In a condition that the pressure in the air supply passage 30 is lower than the predetermined value (a), because the controllable flow rate of the first purge valve 12 is higher than the estimated purge flow rate, the adsorbent canister 11 is purged via the first purge passage 15a without working the purge pump 14. On the other hand, in a condition that the pressure in the air supply passage 30 is equal to or higher than the predetermined value (a), the controllable purge flow rate of the first purge valve 12 is lower than the estimated purge flow rate such that the purge operation via the first purge passage 15a cannot be performed sufficiently. Therefore, in such condition, the second purge valve 13 is opened and the purge pump 14 is operated so as to perform the purge operation via the second purge passage 15b. Because the opening area of the second purge valve 13 in the full open condition is larger than that of the first purge valve 12, the pressure loss at the second purge valve 13 in the second purge passage 15b is less than the pressure loss at the first purge valve 12 in the first purge passage 15a. Accordingly, the controllable flow rate of the second purge valve 13 is higher than the estimated purge flow rate, thereby capable of accomplishing the required purge flow rate.

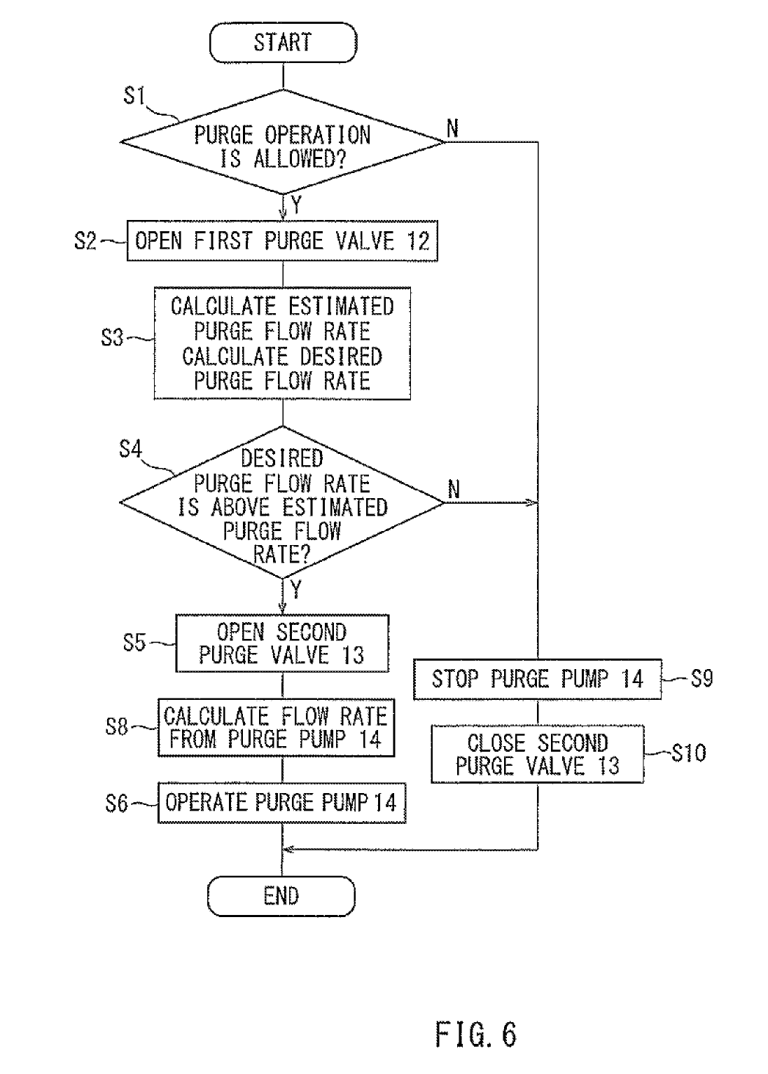

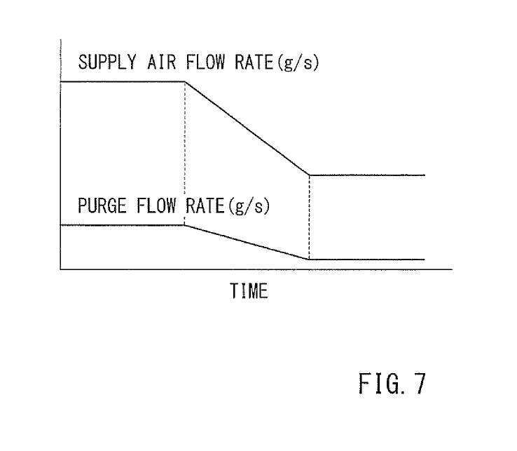

In a third example, the control unit 26 repeatedly carries out a process for controlling the vaporized fuel processing apparatus 10 shown in FIG. 6. The third example generally corresponds to the first example, so that only the differences between the third example and the first example will be described, and the other same or shared configurations will not be described again. In the third example, after the purge operation is allowed at Step S1 and the first purge valve 12 is opened at Step S2, the control unit 26 calculates the estimated purge flow rate and the desired purge flow rate at Step S3, and then it is determined whether the desired purge flow rate is equal to or higher than the estimated purge flow rate at Step S4. When the desired purge flow rate is equal to or higher than the estimated purge flow rate, Step S4 is determined as Yes. Then, the second purge valve 13 is opened at Step S5, and the control unit 26 calculates a desired discharge flow rate of the purge pump 14 at Step S8. The desired discharge flow rate of the purge pump 14 is calculated based on the flow rate of the air supplied to the engine 21 such that the desired discharge flow rate of the purge pump 14, i.e., the purge flow rate corresponds to a certain ratio of the flow rate of the air supplied to the engine 21 as viewed in FIG. 7. At Step S6, the purge pump 14 is operated at the purge flow rate corresponding to the desired discharge flow rate, which has been calculated at Step S8.

According to the third example, when the purge operation is performed while working the purge pump 14, the purge flow rate corresponds to the certain ratio of the flow rate of the air supplied to the engine 21. Thus, the purge flow rate is regulated depending on changes in the flow rate of the air supplied to the engine 21, thereby reducing a variation in the air-fuel ratio in the engine 21, which would be caused by working the purge pump 14 during the purge operation.

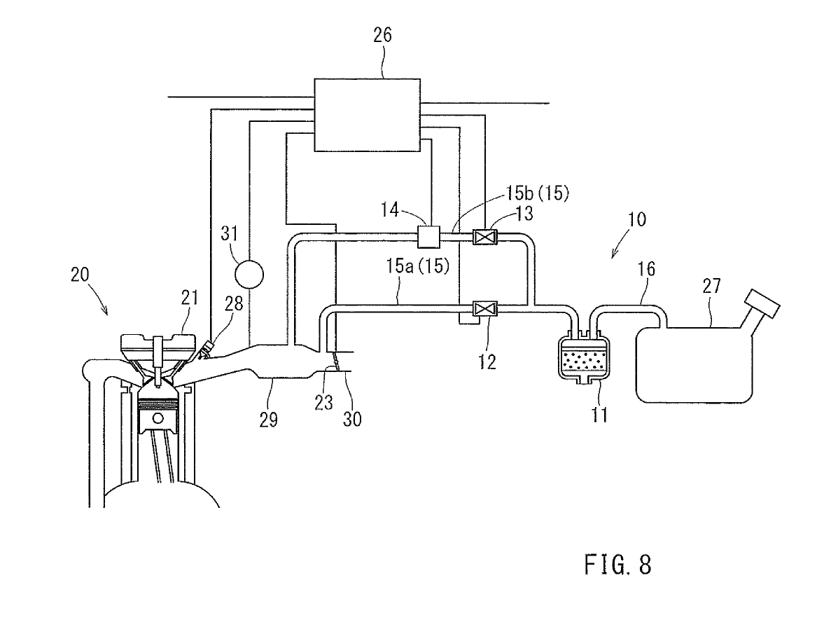

A fourth example will be described in reference to FIG. 8. The engine system 20 of the fourth example has no supercharging device. The second purge passage 15b is connected to a surge tank 29 disposed downstream of the throttle valve 23. Because the other configurations of the fourth example are same with those of the first example, the same configurations will not be described again.

In the fourth example, the control unit 26 controls the first purge valve 12, the second purge valve 13 and the purge pump 14 based on the process shown in FIG. 2. That is, when the desired purge flow rate is below the controllable flow rate of the first purge valve 12, the purge operation is performed via the first purge passage 15a having the first purge valve 12. On the other hand, when the desired purge flow rate is above the controllable flow rate of the first purge valve 12, the second purge valve 13 is opened and the purge pump 14 is operated for securing the required purge flow rate. Because the control unit 26 operates the purge pump 14 depending on necessity for working the purge pump 14, the required purge flow rate can be secured while avoiding unnecessary operation of the purge pump 14.

This disclosure is not limited to the above-described examples and can be modified without departing from the scope of the invention. For example, the supercharging device can be composed of a mechanical supercharger instead of the turbocharger 22. Although negative pressure in the purge passage 15 is used for only purging the adsorbent canister 11 in each example, the negative pressure can be used for other devices such as a blow-by gas reduction device or a brake booster while the adsorbent canister 11 is not purged. Further, although the vaporized fuel processing apparatus 10 is combined with the engine system 20 for the vehicle in each example, this disclosure is not limited to use in the vehicle. In addition, the vaporized fuel processing apparatus 10 can be used for a hybrid vehicle having both an internal combustion engine and an electric motor.

1. A vaporized fuel processing apparatus for an engine including an air supply passage equipped with a throttle valve, the vaporized fuel processing apparatus comprising:
an adsorbent canister adapted to communicate with a fuel tank;
a purge passage communicating the adsorbent canister with the air supply passage of the engine and having a first purge passage and a second purge passage, the first purge passage being formed in parallel with the second purge passage, the first purge passage having a first purge valve, the second purge passage having in series a second purge valve and a purge pump;
wherein the first purge passage and the second purge passage are configured such that pressure loss in the second purge passage is less than pressure loss in the first purge passage.

2. The vaporized fuel processing apparatus according to claim 1, wherein when the first purge valve and the second purge valve are full open, the second purge valve has an opening area larger than that of the first purge valve.

3. The vaporized fuel processing apparatus according to claim 1, wherein the first purge passage is connected to the air supply passage downstream of the throttle valve in a direction of air supply through the air supply passage.

4. The vaporized fuel processing apparatus according to claim 1,
wherein the air supply passage includes a supercharging device; and
wherein the second purge passage is connected to the air supply passage upstream of the supercharging device in a direction of air supply through the air supply passage.

5. The vaporized fuel processing apparatus according to claim 1, further comprising:
a control unit connected to the second purge valve and the purge pump;
wherein the control unit is configured to calculate a desired purge flow rate for the adsorbent canister, and
wherein the control unit is configured to open the second purge valve and to operate the purge pump when the desired purge flow rate is above a controllable flow rate of the first purge valve.

6. The vaporized fuel processing apparatus according to claim 1, further comprising:
a pressure sensor configured to detect pressure in the air supply passage; and
a control unit connected to the pressure sensor, the second purge valve and the purge pump;
wherein the control unit is configured to compare the pressure detected by the pressure sensor with a predetermined value;
wherein the control unit is configured to open the second purge valve and operate the purge pump when the pressure detected by the pressure sensor is above the predetermined value.

7. The vaporized fuel processing apparatus according to claim 1, further comprising:
a flow sensor configured to detect a flow rate of gas flowing into the engine; and
a control unit connected to the flow sensor and the purge pump;
wherein the control unit is configured to regulate the purge pump based on the flow rate detected by the flow sensor.
